(19) United States
(12) Patent Application Publication
(10) Pub. No.: US 2025/0004348 A1
(43) Pub. Date: Jan. 2, 2025

(54) INTEGRATED PHASE MODULATED INTERFEROMETER ARMS

(71) Applicant: SHANGHAI XIZHI TECHNOLOGY CO., LTD., Shanghai (CN)

(72) Inventors: Yichen SHEN, Cambridge, MA (US); Huaiyu MENG, Medford, MA (US); Zhan SU, Boston, MA (US)

(73) Assignee: SHANGHAI XIZHI TECHNOLOGY CO., LTD., Shanghai (CN)

(21) Appl. No.: 18/696,314

(22) PCT Filed: Sep. 30, 2021
(86) PCT No.: PCT/CN2021/122160

§ 371 Date: Mar. 27, 2024

(51) Int. Cl. G02F 1/225; G02F 1/21

(52) U.S. Cl. CPC G02F 1/2257; G02F 1/212; G02F 2203/50

(57) ABSTRACT

An apparatus includes a dual-waveguide optical phase modulator including a first waveguide and a second waveguide, in which each of the first and second waveguides includes a first waveguide core structure and a second waveguide core structure. At least one of the first waveguide core structure or the second waveguide core structure includes a ridge.

### TECHNICAL FIELD

This disclosure relates to integrated phase modulated interferometer arms.

### BACKGROUND

An interferometer generally includes waveguide arms over which optical waves travel between any number of splitters and combiners. The optical waves propagating over the arms can be phase modulated using any of a variety of optical phase modulation techniques. For example, a silicon-insulator-silicon capacitor (SISCAP) type optical phase modulator uses structures that include at least one layer of insulating material between silicon structures that form a waveguide. Such optical phase modulators include structures that allow for voltages to be applied to a capacitor structure for controlling the amount of phase modulation. For some interferometers, such as a Mach-Zehnder interferometer (MZI), there are two such waveguides in relatively close proximity but with enough space surrounding the optical phase modulators to accommodate electrodes for applying voltages, for example, to a capacitor structure of a SISCAP type optical phase modulator.

### SUMMARY

In general, in a first aspect, an integrated photonic device configured to operate on optical waves is provided. The integrated photonic device includes: a substrate supporting structures formed in a plurality of layers of materials with respect to three mutually perpendicular axes. The three mutually perpendicular axes includes: a propagation axis along which two or more of the optical waves propagate over a segment of the photonic device, a depth axis defining depths at which the plurality of layers are formed, and a lateral axis perpendicular to the propagation axis and perpendicular to the depth axis. The integrated photonic device includes an optical phase shifting structure for phase shifting a first optical wave and a second optical wave of the two or more optical waves. The optical phase shifting structure includes: a first layer, above the substrate, including a first semiconductor material including a first doped region that exhibits a first conductivity type, and a second layer, above the substrate and separated from the first layer, including a second semiconductor material including a second doped region that exhibits a second conductivity type opposite from the first conductivity type. At least one of the first layer or the second layer includes at least one ridge of its respective semiconductor material extending along the depth axis into a portion of a volume between the first layer and the second layer. At least one of the first layer or the second layer includes a segment of the dielectric material separating two portions of its respective doped region across the lateral axis to separate the first optical wave from the second optical wave.

Implementations can include one or more of the following features. The integrated photonic device can further include a third layer, between at least a portion of the volume between the first layer and the second layer, including the dielectric material.

The integrated photonic device can further include: a first electrode contacting a portion of the first doped region on a first side of the segment of the dielectric material; a second electrode contacting a portion of the second doped region on the first side of the segment of the dielectric material; a third electrode contacting a portion of the first doped region on a second side of the segment of the dielectric material; and a fourth electrode contacting a portion of the second doped region on the second side of the segment of the dielectric material.

The first layer can be above the second layer, and the portion of the second doped region on the first side of the segment of the dielectric material can extend further along the lateral axis from the segment of the dielectric material than the portion of the first doped region on the first side of the segment of the dielectric material.

The portion of the second doped region on the second side of the segment of the dielectric material can extend further along the lateral axis from the segment of the dielectric material than the portion of the first doped region on the second side of the segment of the dielectric material.

The integrated photonic device can further include a fourth layer, between the substrate and the first layer, including the dielectric material.

The fourth layer can include a buried oxide layer of a silicon on insulator (SOI) integrated circuit.

The segment of the dielectric material can contact the fourth layer.

The first layer and the second layer can each include a segment of the dielectric material separating two portions of its respective doped region across the lateral axis to separate the peak of an optical spatial mode of the first optical wave from the peak of an optical spatial mode of the second optical wave.

The segment of the first layer and the segment of the second layer can each contact the third layer.

The integrated photonic device can further include a fifth layer, above both the first layer and the second layer, including the dielectric material.

The segment of the dielectric material can separate a first ridge of the first semiconductor material of the first layer and a second ridge of the first semiconductor material of the first layer, the first ridge can extend along the propagation axis to provide a first waveguide section to guide the optical spatial mode of the first optical wave, and the second ridge can extend along the propagation axis to provide a second waveguide section to guide the optical spatial mode of the second optical wave.

The first waveguide section and the second waveguide section can be configured to form portions of respective arms of an interferometric structure.

The interferometric structure can include at least a portion of a Mach-Zehnder interferometer.

Each of the first waveguide section and the second waveguide section can include a semiconductor-insulator-semiconductor capacitor (SISCAP).

A size of the segment of the dielectric material separating two portions of its respective doped region across the lateral axis can be between about 1 micron to 50 microns.

A size of the segment of the dielectric material separating two portions of its respective doped region across the lateral axis can be between about 2 microns to 20 microns.

Different portions of the first doped region can have different concentrations of dopant, and different portions of the second doped region can have different concentrations of dopant.

In another general aspect, a method for fabricating an integrated photonic device configured to operate on optical waves is provided. The method includes: forming a substrate supporting structures formed in a plurality of layers of materials with respect to three mutually perpendicular axes. The three mutually perpendicular axes includes: a propagation axis along which two or more of the optical waves propagate over a segment of the photonic device, a depth axis defining depths at which the plurality of layers are formed, and a lateral axis perpendicular to the propagation axis and perpendicular to the depth axis. The method includes forming an optical phase shifting structure for phase shifting a first optical wave and a second optical wave of the two or more optical waves. The optical phase shifting structure includes: a first layer, above the substrate, includes a first semiconductor material including a first doped region that exhibits a first conductivity type, and a second layer, above the substrate and separated from the first layer, includes a second semiconductor material including a second doped region that exhibits a second conductivity type opposite from the first conductivity type. The method includes forming in at least one of the first layer or the second layer at least one ridge of its respective semiconductor material extending along the depth axis into a portion of a volume between the first layer and the second layer; and forming in at least one of the first layer or the second layer a segment of the dielectric material separating two portions of its respective doped region across the lateral axis to separate the first optical wave from the second optical wave.

Implementations can include one or more of the following features. The method can include forming a third layer, between at least a portion of the volume between the first layer and the second layer, in which the third layer includes the dielectric material.

The method can further include: forming a first electrode contacting a portion of the first doped region on a first side of the segment of the dielectric material; forming a second electrode contacting a portion of the second doped region on the first side of the segment of the dielectric material; forming a third electrode contacting a portion of the first doped region on a second side of the segment of the dielectric material; and forming a fourth electrode contacting a portion of the second doped region on the second side of the segment of the dielectric material.

The first layer can be above the second layer, and the portion of the second doped region on the first side of the segment of the dielectric material can extend further along the lateral axis from the segment of the dielectric material than the portion of the first doped region on the first side of the segment of the dielectric material.

The portion of the second doped region on the second side of the segment of the dielectric material can extend further along the lateral axis from the segment of the dielectric material than the portion of the first doped region on the second side of the segment of the dielectric material.

The method can further include forming a fourth layer, between the substrate and the first layer, in which the fourth layer includes the dielectric material.

The fourth layer can include a buried oxide layer of a silicon on insulator (SOI) integrated circuit.

The segment of the dielectric material can contact the fourth layer.

The first layer and the second layer can each include a segment of the dielectric material separating two portions of its respective doped region across the lateral axis to separate the peak of an optical spatial mode of the first optical wave from the peak of an optical spatial mode of the second optical wave.

The segment of the first layer and the segment of the second layer can each contact the third layer.

The method can further include forming a fifth layer, above both the first layer and the second layer, in which the fifth layer includes the dielectric material.

The segment of the dielectric material can separate a first ridge of the first semiconductor material of the first layer and a second ridge of the first semiconductor material of the first layer, the first ridge can extend along the propagation axis to provide a first waveguide section to guide the optical spatial mode of the first optical wave, and the second ridge can extend along the propagation axis to provide a second waveguide section to guide the optical spatial mode of the second optical wave.

The method include forming portions of respective arms of an interferometric structure using the first waveguide section and the second waveguide section.

The method can include forming a Mach-Zehnder interferometer that includes the interferometric structure.

Each of the first waveguide section and the second waveguide section can include a semiconductor-insulator-semiconductor capacitor (SISCAP).

A size of the segment of the dielectric material separating two portions of its respective doped region across the lateral axis can be between about 1 micron to 50 microns.

A size of the segment of the dielectric material separating two portions of its respective doped region across the lateral axis can be between about 2 microns to 20 microns.

Different portions of the first doped region can have different concentrations of dopant, and different portions of the second doped region can have different concentrations of dopant.

In another general aspect, an apparatus includes: a dual-waveguide optical phase modulator including a first waveguide and a second waveguide. Each of the first and second waveguides includes: a first waveguide core structure and a second waveguide core structure, in which at least one of the first waveguide core structure or the second waveguide core structure includes a ridge.

Implementations can include one or more of the following features. The first waveguide and the second waveguide can extend along a propagation direction, and the first waveguide core structure and the second waveguide core structure can be spaced apart in a depth direction perpendicular to the propagation direction.

The first waveguide core structure can include a first semiconductor material including a first doped region that exhibits a first conductivity type, and the second waveguide core structure can include a second semiconductor material including a second doped region that exhibits a second conductivity type opposite from the first conductivity type.

Each of the first waveguide and the second waveguide can include a dielectric material disposed between the first waveguide core structure and the second waveguide core structure.

The first waveguide and the second waveguide can extend along a propagation direction, and the first waveguide core structure of the first waveguide can be spaced apart from the first waveguide core structure of the second waveguide in a lateral direction perpendicular to the propagation direction.

The first waveguide core structure can include the ridge.

The second waveguide core structure can include the ridge.

The second waveguide core structure does not include a ridge.

The second waveguide core structure can include the ridge, and the first waveguide core structure does not include a ridge.

The second waveguide core structure of the first waveguide and the second waveguide core structure of the second waveguide can form a continuous waveguide core structure.

The second waveguide core structure of the first waveguide can be spaced apart from the second waveguide core structure of the second waveguide in a lateral direction perpendicular to the propagation direction.

The first waveguide core structure of each of the first waveguide and the second waveguide can include a first semiconductor material including a first doped region that exhibits a first conductivity type. The dual-waveguide optical phase modulator can include a segment of a dielectric material disposed between the first waveguide core structure of the first waveguide and the first waveguide core structure of the second waveguide.

The segment of the dielectric material can be configured to separate a peak of an optical spatial mode of a first optical wave propagating in the first waveguide from a peak of an optical spatial mode of a second optical wave propagating in the second waveguide.

The second waveguide core structure of each of the first waveguide and the second waveguide can include a second semiconductor material including a second doped region that exhibits a second conductivity type opposite from the first conductivity type. The dual-waveguide optical phase modulator can include a segment of dielectric material disposed between the second waveguide core structure of the first waveguide and the second waveguide core structure of the second waveguide.

The second waveguide core structure of the first waveguide and the second waveguide core structure of the second waveguide can form a continuous waveguide core structure and can include a second semiconductor material including a second doped region that exhibits a second conductivity type opposite from the first conductivity type.

The apparatus can include: a first pair of electrodes electrically coupled to the first and second waveguide core structures of the first waveguide, and a second pair of electrodes electrically coupled to the first and second waveguide core structures of the second waveguide. The first pair of electrodes can be disposed at a first side in a lateral direction relative to the dielectric material, and the second pair of electrodes can be disposed at a second side in a lateral direction relative to the dielectric material.

The apparatus can include a substrate, in which the first waveguide core structure can be formed in a first layer above the substrate, the second waveguide core structure can be formed in a second layer above the substrate, and the first layer can be above the second layer.

Each of the first waveguide and the second waveguide can include a semiconductor-insulator-semiconductor capacitor (SISCAP).

The segment of the dielectric material can separate a first ridge of the first waveguide and a second ridge of the second waveguide, the first ridge can extend along a propagation direction of the first waveguide to provide a first waveguide section to guide an optical spatial mode of a first optical wave propagating in the first waveguide, and the second ridge can extend along a propagation direction of the second waveguide to provide a second waveguide section to guide an optical spatial mode of a second optical wave propagating in the second waveguide.

The apparatus can include an interferometric structure, in which the first waveguide and the second waveguide can be configured to form portions of respective arms of the interferometric structure.

The apparatus can include a Mach-Zehnder interferometer that includes the interferometric structure.

The segment of the dielectric material can be configured to separate the first waveguide core structure of the first waveguide from the first waveguide core structure of the second waveguide at a distance in a range from 1 micron to 50 microns.

The segment of the dielectric material can be configured to separate the first waveguide core structure of the first waveguide from the first waveguide core structure of the second waveguide at a distance in a range from 2 microns to 20 microns.

Different portions of the first doped region can have different concentrations of dopant.

Different portions of the second doped region can have different concentrations of dopant.

On a plane perpendicular to a propagation direction of the first and second waveguides, the first waveguide can be symmetrical to the second waveguide with respect to a midline between the first waveguide and the second waveguide.

The first waveguide can be symmetrical to the second waveguide with respect to a plane between the first waveguide and the second waveguide.

In another general aspect, a system includes: a processor unit including: a light source configured to provide a plurality of light outputs; and a plurality of optical modulators coupled to the light source and the first unit, the plurality of optical modulators being configured to generate an optical input vector by modulating the plurality of light outputs provided by the light source based on a plurality of modulator control signals, the optical input vector comprising a plurality of optical signals. The processor unit includes a matrix multiplication unit coupled to the plurality of optical modulators, the matrix multiplication unit being configured to transform the optical input vector into an output vector based on a plurality of weight control signals. At least one of the optical modulators includes any of the integrated photonic devices described above, or any of the apparatuses described above, or an integrated photonic device fabricated according to any of the methods described above.

Implementations can include the following feature. Each of the optical modulators can include any of the integrated photonic devices described above, or any of the apparatuses described above, or an integrated photonic device fabricated according to any of the methods described above.

In another general aspect, an optical processor that includes a plurality of optical modulators is provided, in which at least one of the optical modulators includes any of the integrated photonic devices described above, or any of the apparatuses described above, or an integrated photonic device fabricated according to any of the methods described above.

Implementations can include the following feature. Each of the optical modulators can include any of the integrated photonic devices described above, or any of the apparatuses described above, or an integrated photonic device fabricated according to any of the methods described above.

In another general aspect, a system includes at least one of a robot, an autonomous vehicle, an autonomous drone, a medical diagnosis system, a fraud detection system, a weather prediction system, a financial forecast system, a facial recognition system, a speech recognition system, or a product defect detection system is provided. The at least one of a robot, an autonomous vehicle, an autonomous drone, a medical diagnosis system, a fraud detection system, a weather prediction system, a financial forecast system, a facial recognition system, a speech recognition system, or a product defect detection system includes any of the integrated photonic devices described above, or any of the apparatuses described above, or an integrated photonic device fabricated according to any of the methods described above.

Aspects can have one or more of the following advantages.

The techniques described herein can be used to form relatively compact optical phase modulator structures for interferometer devices in which the waveguide arms are relatively close to each other. Instead of requiring two electrical contact structures on either side of a single waveguide, some implementations only require two electrical contact structures on either side of a pair of closely spaced waveguides, as described in more detail below. This may be particularly useful, for example, if there are a large number of such interferometer devices in an array, such as in an optical computing device that uses an array of MZIs for matrix multiplication or another operation that is being performed on a large number of optical waves. In some implementations, the interferometer devices are integrated in the same photonic integrated circuit. The compact arrangement of MZIs requiring less area for contact structures enables a smaller chip size for a resulting device, and/or a higher density of MZIs in the resulting device.

Unless otherwise defined, all technical and scientific terms used herein have the same meaning as commonly understood by one of ordinary skill in the art to which this invention belongs. In case of conflict with patent applications or patent application publications incorporated herein by reference, the present specification, including definitions, will control.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of a cross-sectional view of a dual-waveguide optical phase modulator.

FIG. 1B is a schematic diagram of a top view of the dual-waveguide optical phase modulator.

FIGS. 2A-2I are schematic diagrams of cross-sectional views of various configurations of waveguide pairs.

FIG. 3 is a flowchart for an example fabrication procedure for fabricating a dual-waveguide optical phase modulator.

Like reference numbers and designations in the various drawings indicate like elements.

### DETAILED DESCRIPTION

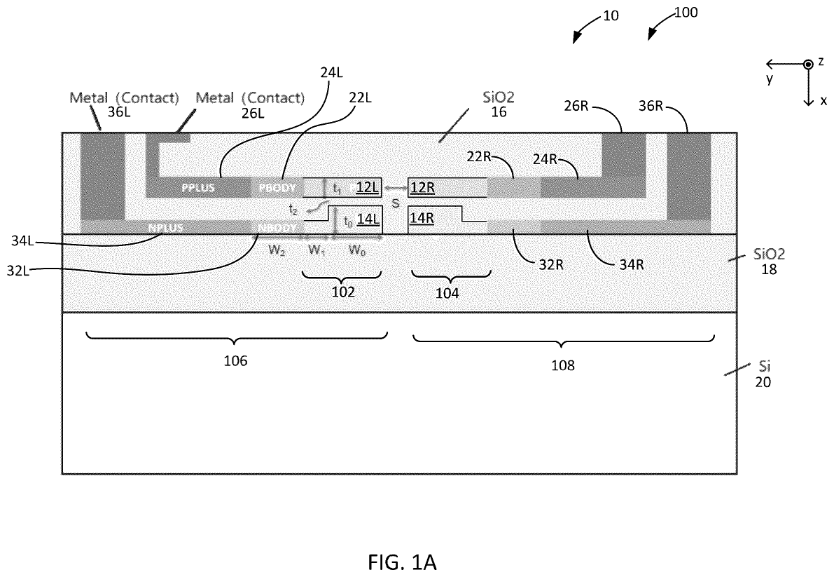

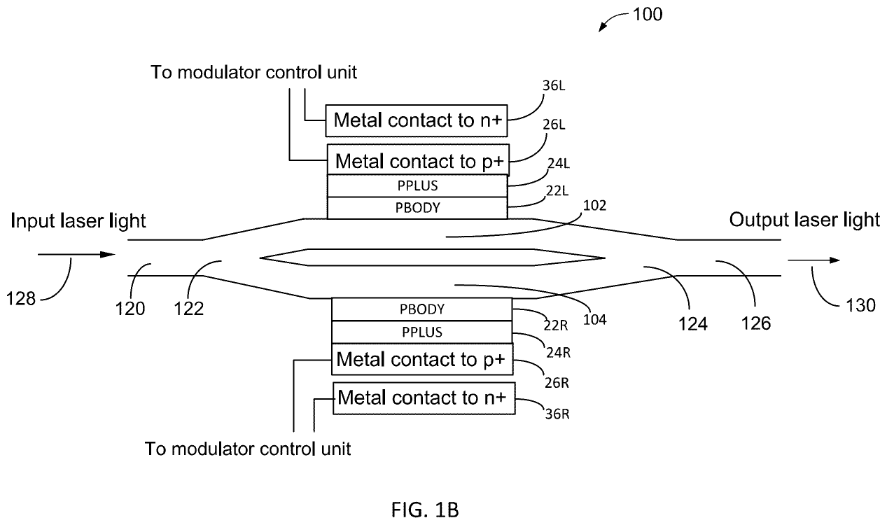

FIG. 1A shows a cross-sectional view of a dual-waveguide optical phase modulator 100 that includes a left optical phase modulator 106 and a right optical phase modulator 108. The left optical phase modulator 106 includes a left waveguide 102, and the right optical phase modulator 108 includes a right waveguide 104. The plane of the cross-section is perpendicular to the propagation axis (z—into the page) of the waveguides in this example. Different layers are shown along a depth axis (x), with the left waveguide 102 and the right waveguide 104 separated along a lateral axis (y). The left and right waveguides 102, 104 can be included in an interferometer, such as an MZI that uses a push-pull configuration for modulating the optical waves propagating in the arms of the MZI between an optical splitter and an optical combiner, for example. There can be any number of segments of optical phase modulators along each of the waveguides, such as in a segmented design that uses segments whose lengths are proportional to a magnitude of a different bit in digital-to-analog conversion device. The view of FIG. 1A is a cross-section 10 of one such pair of optical phase modulators that use a SISCAP configuration for changing the index of refraction in a portion of their respective waveguides.

The left optical phase modulator 106 includes a SISCAP structure, which includes an upper waveguide core structure 12L formed from a p-type lightly doped portion of an upper silicon layer, a lower waveguide core structure 14L formed from an n-type lightly doped portion of a lower silicon layer, and an insulating material layer 110L between them. The lower waveguide core structure 14L has a ridge that defines a thin layer of insulator material (e.g., silicon dioxide, or other oxide or dielectric material) between the upper waveguide core structure 12L and lower waveguide core structure 14L. The figure is not to-scale (for ease of viewing), but in a practical implementation the vertical thickness to of the lower waveguide core structure 14L and the vertical thickness t₁ of the upper waveguide core structure 12L can both be significantly larger than the vertical thickness t₂ of the layer of insulating material between them (e.g., by an order of magnitude or more).

In some implementations, these thicknesses can be selected to have values within the following exemplary ranges: t₀ can be in a range from 150 nm to 500 nm, t¹ can be in a range from 100 nm to 250 nm, and t₂ can be in a range from 0.5 nm to 15 nm. A transverse spatial mode of a guided optical wave in the left optical phase modulator 106 is confined vertically by these waveguide core structures 12L and 14L, which have a larger index of refraction than the thicker SiO₂ cladding structures 16 and 18, and confined laterally by the width W₀ of the ridge of the lower waveguide core structure 14L. The right optical phase modulator 108 includes a SISCAP structure, which includes corresponding structures, including an upper waveguide core structure 12R formed from a p-type lightly doped portion of an upper silicon layer, a lower waveguide core structure 14R formed from an n-type lightly doped portion of a lower silicon layer, and an insulating layer between them.

In this example, the lower cladding structure 18 is a buried oxide (BOX) layer of a silicon-on-insulator integrated circuit that includes a thick silicon substrate 20, the BOX cladding structure 18, and a thin silicon layer on top of the BOX cladding structure 18. The thin silicon layer can be used for forming portions of the lower waveguide core structures 14L and 14R, with other layers of SiO₂ and silicon (e.g., polycrystalline silicon) on top to form the upper waveguide core structures 12L and 12R and the SiO₂ cladding structure 16 between and above the other structures.

There fabrication steps include doping portions of the upper waveguide core structures with dopants providing a particular conductivity type (with electrons as the majority carrier type with an n-type dopant, or holes as the majority carrier type with a p-type dopant), and doping portions of the lower waveguide core structures with dopants providing an opposite conductivity type as the upper waveguide core structures. For example, to implement a waveguide core structure with electrons as the majority charge carrier type (or electron conductivity type), an n-type dopant or impurity can be used to provide donor electrons. To implement a waveguide core structure with holes as the majority charge carrier type (or hole conductivity type), a p-type dopant or impurity that is an electron acceptor can be used. The waveguide core structures can be doped with a relatively light concentration of dopants (p-type for the structures 12L and 12R, and n-type for the structures 14L and 14R). The light doping is helpful for reducing optical losses associated with the propagating optical waves, for example. There can also be sections doped with heavier doping concentrations to provide access to electrical contacts on the surface of the cladding structure 16.

The cross-section 10 shows a medium concentration p-type doped section 22L adjacent to the upper waveguide core structure 12L that has a higher doping concentration than the upper waveguide core structure 12L, and a heavy concentration p-type doped section 24L adjacent to the section 22L that has a higher doping concentration than the section 22L. The heavy doping concentration is useful for forming an electrical connection to a metal via and contact structure 26L. Similarly, there is a medium concentration n-type doped section 32L adjacent to the lower waveguide core structure 14L that has a higher doping concentration than the lower waveguide core structure 14L, and a heavy concentration n-type doped section 34L adjacent to the section 32L that has a higher doping concentration than the section 32L. The section 34L is also connected to a metal via and contact structure 36L.

Corresponding doped sections 22R, 24R, 32R, 34R for electrically connecting to metal vias and contact structures 26R, 36R are included on the right side for the right SISCAP structure of the right optical phase modulator 108 associated with the upper waveguide core structure 12R and the lower waveguide cores structure 14R.

The width of the lightly doped portion of the lower waveguide core structure 14L can extend past the ridge of width W₀ by an additional width W₁, and the medium doped section 32L can have a width W₂ that provides a suitable buffer before the heavily doped section 34L is reached. In some implementations, these widths can be selected to have values within the following exemplary ranges: W₀ can be in a range from 250 nm to 500 nm, W₁ can be in a range from 100 nm to 1,000 nm, and W₂ can be in a range from 400 nm to 2,000 nm, for example.

A separation distance S between the left and right waveguide core structures of the left and right optical phase modulators 106, 108 can be selected such that the optical waves guided in the left core structures 12L, 14L are separated from the optical waves guided in the right core structures 12R, 14R. For example, S can be selected such that the centers of the transverse spatial modes being guided in the two waveguides 102, 104 are separated and such that there is minimal overlap between the transverse spatial modes of the optical waves, which reduces any residual coupling (e.g., evanescent coupling) between the two waveguides 102, 104 that could cause undesirable crosstalk in an optical device. For example, for the size ranges described above and the associated transverse spatial mode sizes, a minimum value for S of around 5 μm can be used to reduce potential crosstalk. In some implementations, the separation distance S can be smaller (e.g., 2 μm or 1 μm) and still limit crosstalk to acceptable levels. Or, the separation distance can be larger in some implementations (e.g., 10 μm or more). In some examples, S is in a range from 1 μm to 50 μm. In some examples, S is in a range from 2 μm to 20 μm.

A portion of the SiO₂ cladding structure 16 is formed (e.g., deposited or grown) between the doped upper waveguide core structure 12L and lower waveguide core structure 14L to serve as an insulating layer 110L of an active region of a SISCAP structure that overlaps with the optical mode being guided by the waveguide core structures and surrounding cladding. The adjacent doped sections extend from these active regions to the left for the left SISCAP structure (of the left optical phase modulator 106), and to the right for the right SISCAP structure (of the right optical phase modulator 108). This enables the waveguides 102, 104 of the two adjacent optical phase modulators to be closer to each other without requiring electrical contacts on both sides of both SISCAP structures.

The pair of electrical contacts of the structures 26L and 36L enable an electrical signal (e.g., a voltage signal) to be applied to the left SISCAP structure of the left optical phase modulator 106. The charge distribution, and corresponding carrier distribution, associated with the SISCAP structure can be adjusted by adjusting the voltage applied between the electrical contacts of the structures 26L and 36L. As the carrier distribution changes, the refractive index of the active region also changes, which changes the effective refractive index associated with the optical wave that is propagating in the waveguide 102, modulating the optical phase of that optical wave.

Similarly, a pair of electrical contacts of the structures 26R and 36R are electrically coupled to the upper waveguide core structure 12R and the lower waveguide core structure 14R, respectively, to enable an electrical signal (e.g., a voltage signal) to be applied to the right SISCAP structure of the right optical phase modulator 108. The charge distribution, and corresponding carrier distribution, associated with the SISCAP structure can be adjusted by adjusting the voltage applied between the electrical contacts of the structures 26R and 36R. As the carrier distribution changes, the refractive index of the active region also changes, which changes the effective refractive index associated with the optical wave that is propagating in the waveguide 104, modulating the optical phase of that optical wave.

FIG. 1B is a top view of an example of an optical device that includes the dual-waveguide optical phase modulator 100. An input waveguide 120 is coupled a Y-coupler (or Y-branch) 122 that is coupled to the input ends of the waveguides 102 and 104. The output ends of the waveguides 102 and 104 are coupled to a Y-coupler (or Y-branch) 124 that is coupled to an output waveguide 126. An input optical wave 128 propagating in the input waveguide 120 is split by the Y-coupler 122 to propagate along the waveguides 102 and 104. A modulator control unit (not shown) transmits modulation control signals to the metal contacts 26L, 36L to modulate the phase of the optical wave propagating in the waveguide 102. The modulator control unit transmits modulation control signals to the metal contacts 26R, 36R to modulate the phase of the optical wave propagating in the waveguide 104. The modulated optical waves in the waveguides 102 and 104 are recombined at the Y-coupler 124 to generate a modulated output signal 130 that propagates along the output waveguide 126. In this example, the medium concentration n-type doped section 32L and the heavy concentration n-type doped section 34L are below the medium concentration p-type doped section 22L and the heavy concentration p-type doped section 24L, respectively, and are not shown in the figure. Similarly, the medium concentration n-type doped section 32R and the heavy concentration n-type doped section 34R are below the medium concentration p-type doped section 22R and the heavy concentration p-type doped section 24R, respectively, and are not shown in the figure.

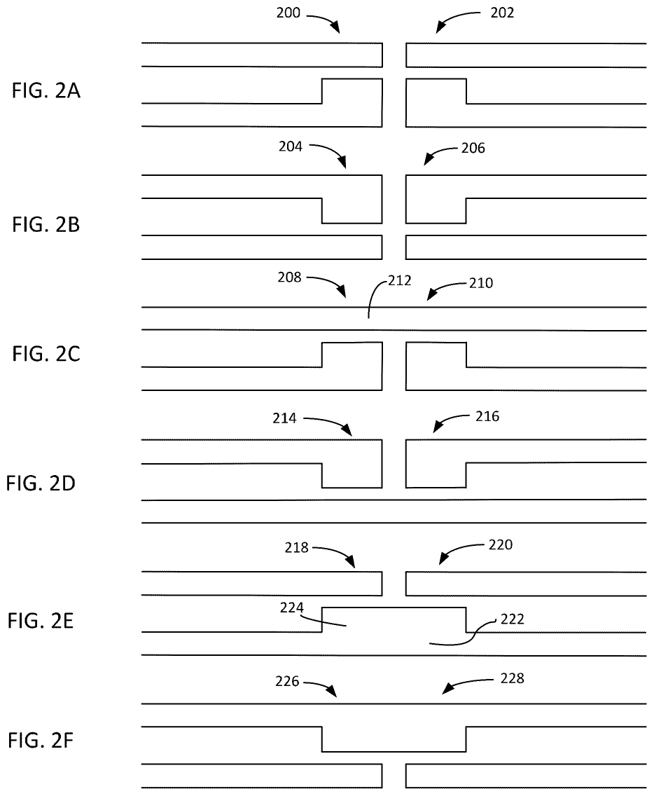

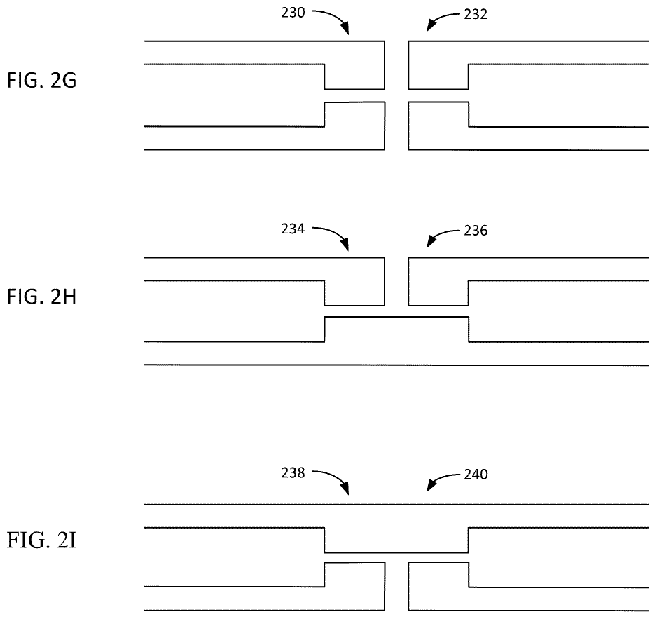

FIGS. 2A-2I show a variety of alternative configurations for the adjacent SISCAP structures that still enable the adjacent waveguides to provide separated optical modes that can be part of a device that uses relative optical phase modulation in adjacent arms (e.g., an interferometric device such as an MZI). FIGS. 2A to 2I show cross-sectional views of the dual-waveguide configurations, in which the plane of the cross-section is perpendicular to the propagation axis (z-into the page) of the waveguides, similar to the example in FIGS. 1A, 1B. FIG. 2A shows an example of a pair of waveguides 200, 202 that corresponds to the geometry of FIGS. 1A, 1B.

FIG. 2B shows an example of a pair of waveguides 204, 206 that is a vertically flipped version of the pair of waveguides 200, 202 of FIG. 2A with the ridges of the waveguide core structure on the upper waveguide core structures instead of the lower waveguide core structures.

FIG. 2C shows an example of a pair of waveguides 208, 210 similar to the example of FIG. 2A, but with the upper waveguide core structures connected to form a continuous upper waveguide core structure 212. The lightly doped portion of semiconductor material of which the upper waveguide core structures are formed is extended across what was the separation distance. In this example, even though the upper waveguide core structure 212 extends across both waveguides 208, 210, because the lower waveguide core structures are spaced apart, there is still minimal overlap between the transverse spatial modes of the optical waves propagating in the waveguides 208, 210, which reduces any residual coupling (e.g., evanescent coupling) between the two waveguides 208 and 210.

FIG. 2D shows an example of a pair of waveguides 214, 216 that is a vertically flipped version of the pair of waveguides 208, 210 shown in FIG. 2C.

FIG. 2E shows an example of a pair of waveguides 218, 220 similar to the example of FIG. 2A, but with the lower waveguide core structures connected to form a continuous lower waveguide core structure 222. The lightly doped portion of semiconductor material of which the lower ridged waveguide core structures are formed is extended across what was the separation distance, forming a continuous lower ridged waveguide core structure 224.

FIG. 2F shows an example of a pair of waveguides 226, 228 that is a vertically flipped version of the pair of waveguides 218, 220 shown in FIG. 2E.

FIG. 2G shows an example of a pair of waveguides 230, 232 in which the upper waveguide core structures include ridges, and the lower waveguide core structures also include ridges. The depth of the ridges of the lower waveguide core structures can be the same or different from the depth of the ridges of the upper waveguide core structures. The width of the ridges of the lower waveguide core structures can be the same or different from the width of the ridges of the upper waveguide core structures.

FIG. 2H shows an example of a pair of waveguides 234, 236 in which the upper waveguide core structures include ridges, and the lower waveguide core structures form a continuous lower waveguide core structure that include a ridge. The depth of the ridges of the upper waveguide core structures can be the same or different from the depth of the ridge of the lower waveguide core structure. The width from the left edge of the upper left side ridge to the right edge of the upper right side ridge of the upper waveguide core structures can be the same or different from the width of the ridge of the lower waveguide core structure.

FIG. 2I shows an example of a pair of waveguides 238, 240 that is a vertically flipped version of the pair of waveguides 234, 236 shown in FIG. 2H.

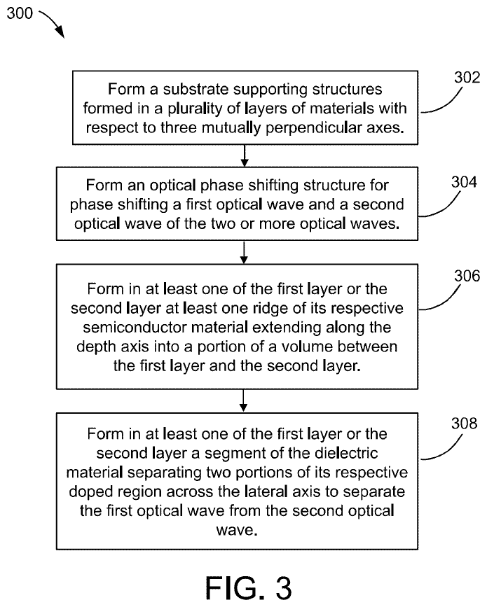

FIG. 3 shows an example of a fabrication process 300 for fabricating a dual-waveguide optical phase modulator. The process 300 includes forming (302) a substrate supporting structures formed in a plurality of layers of materials with respect to three mutually perpendicular axes. The three mutually perpendicular axes include: a propagation axis along which two or more of the optical waves propagate over a segment of the photonic device, a depth axis defining depths at which the plurality of layers are formed, and a lateral axis perpendicular to the propagation axis and perpendicular to the depth axis.

The process 300 includes forming (304) an optical phase shifting structure for phase shifting a first optical wave and a second optical wave of the two or more optical waves. The optical phase shifting structure includes a first layer above the substrate and includes a first semiconductor material including a first doped region that exhibits a first conductivity type. The optical phase shifting structure includes a second layer above the substrate and separated from the first layer, the second layer including a second semiconductor material including a second doped region that exhibits a second conductivity type opposite from the first conductivity type.

The process 300 includes forming (306) in at least one of the first layer or the second layer at least one ridge of its respective semiconductor material extending along the depth axis into a portion of a volume between the first layer and the second layer.

The process 300 includes forming (308) in at least one of the first layer or the second layer a segment of the dielectric material separating two portions of its respective doped region across the lateral axis to separate the first optical wave from the second optical wave.

These fabrication steps can be performed in any order.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law. For example, various types of input coupling structures can be used to couple the optical waveguides 102 and 104 to input waveguides, and various types of output coupling structures can be used to couple the optical waveguides 102 and 104 to output waveguides. For example, the left waveguide 102 and the right waveguide 104 do not necessarily have to be straight extending along the propagation axis, and can also be curved along a plane perpendicular to the depth axis (x), or curved in other configurations.

Although the present invention is defined in the attached claims, it should be understood that the present invention can also be defined in accordance with the following sets of embodiments:

Embodiment 1: An integrated photonic device configured to operate on optical waves, the integrated photonic device comprising:
a substrate supporting structures formed in a plurality of layers of materials with respect to three mutually perpendicular axes comprising:
   a propagation axis along which two or more of the optical waves propagate over a segment of the photonic device,
   a depth axis defining depths at which the plurality of layers are formed, and
   a lateral axis perpendicular to the propagation axis and perpendicular to the depth axis; and
an optical phase shifting structure for phase shifting a first optical wave and a second optical wave of the two or more optical waves comprising:
   a first layer, above the substrate, comprising a first semiconductor material including a first doped region that exhibits a first conductivity type, and
   a second layer, above the substrate and separated from the first layer, comprising a second semiconductor material including a second doped region that exhibits a second conductivity type opposite from the first conductivity type;
wherein at least one of the first layer or the second layer includes at least one ridge of its respective semiconductor material extending along the depth axis into a portion of a volume between the first layer and the second layer; and
wherein at least one of the first layer or the second layer includes a segment of the dielectric material separating two portions of its respective doped region across the lateral axis to separate the first optical wave from the second optical wave.

Embodiment 2: The integrated photonic device of embodiment 1, further comprising a third layer, between at least a portion of the volume between the first layer and the second layer, comprising the dielectric material.

Embodiment 3: The integrated photonic device of embodiment 2, further comprising:
a first electrode contacting a portion of the first doped region on a first side of the segment of the dielectric material;
a second electrode contacting a portion of the second doped region on the first side of the segment of the dielectric material;
a third electrode contacting a portion of the first doped region on a second side of the segment of the dielectric material; and
a fourth electrode contacting a portion of the second doped region on the second side of the segment of the dielectric material.

Embodiment 4: The integrated photonic device of embodiment 3, wherein the first layer is above the second layer, and the portion of the second doped region on the first side of the segment of the dielectric material extends further along the lateral axis from the segment of the dielectric material than the portion of the first doped region on the first side of the segment of the dielectric material.

Embodiment 5: The integrated photonic device of embodiment 4, wherein the portion of the second doped region on the second side of the segment of the dielectric material extends further along the lateral axis from the segment of the dielectric material than the portion of the first doped region on the second side of the segment of the dielectric material.

Embodiment 6: The integrated photonic device of any of embodiments 2 to 5, further comprising a fourth layer, between the substrate and the first layer, comprising the dielectric material.

Embodiment 7: The integrated photonic device of embodiment 6, wherein the fourth layer comprises a buried oxide layer of a silicon on insulator (SOI) integrated circuit.

Embodiment 8: The integrated photonic device of embodiment 6 or 7, wherein the segment of the dielectric material contacts the fourth layer.

Embodiment 9: The integrated photonic device of embodiment 8, wherein the first layer and the second layer each include a segment of the dielectric material separating two portions of its respective doped region across the lateral axis to separate the peak of an optical spatial mode of the first optical wave from the peak of an optical spatial mode of the second optical wave.

Embodiment 10: The integrated photonic device of embodiment 9, wherein the segment of the first layer and the segment of the second layer each contact the third layer.

Embodiment 11: The integrated photonic device of any of embodiments 6 to 10, further comprising a fifth layer, above both the first layer and the second layer, comprising the dielectric material.

Embodiment 12: The integrated photonic device of any of embodiments 1 to 11, wherein the segment of the dielectric material separates a first ridge of the first semiconductor material of the first layer and a second ridge of the first semiconductor material of the first layer, the first ridge extends along the propagation axis to provide a first waveguide section to guide the optical spatial mode of the first optical wave, and the second ridge extends along the propagation axis to provide a second waveguide section to guide the optical spatial mode of the second optical wave.

Embodiment 13: The integrated photonic device of embodiment 12, wherein the first waveguide section and the second waveguide section are configured to form portions of respective arms of an interferometric structure.

Embodiment 14: The integrated photonic device of embodiment 13, wherein the interferometric structure comprises at least a portion of a Mach-Zehnder interferometer.

Embodiment 15: The integrated photonic device of any of embodiments 12 to 14, wherein each of the first waveguide section and the second waveguide section comprises a semiconductor-insulator-semiconductor capacitor (SISCAP).

Embodiment 16: The integrated photonic device of any of embodiments 1 to 15, wherein a size of the segment of the dielectric material separating two portions of its respective doped region across the lateral axis is between about 1 micron to 50 microns.

Embodiment 17: The integrated photonic device of embodiment 16, wherein a size of the segment of the dielectric material separating two portions of its respective doped region across the lateral axis is between about 2 microns to 20 microns.

Embodiment 18: The integrated photonic device of any of embodiments 1 to 17, wherein different portions of the first doped region have different concentrations of dopant, and different portions of the second doped region have different concentrations of dopant.

Embodiment 19: A method for fabricating an integrated photonic device configured to operate on optical waves, the method comprising:
forming a substrate supporting structures formed in a plurality of layers of materials with respect to three mutually perpendicular axes comprising:
   a propagation axis along which two or more of the optical waves propagate over a segment of the photonic device,
   a depth axis defining depths at which the plurality of layers are formed, and
   a lateral axis perpendicular to the propagation axis and perpendicular to the depth axis;
forming an optical phase shifting structure for phase shifting a first optical wave and a second optical wave of the two or more optical waves comprising:
   a first layer, above the substrate, comprising a first semiconductor material including a first doped region that exhibits a first conductivity type, and
   a second layer, above the substrate and separated from the first layer, comprising a second semiconductor material including a second doped region that exhibits a second conductivity type opposite from the first conductivity type;
forming in at least one of the first layer or the second layer at least one ridge of its respective semiconductor material extending along the depth axis into a portion of a volume between the first layer and the second layer; and
forming in at least one of the first layer or the second layer a segment of the dielectric material separating two portions of its respective doped region across the lateral axis to separate the first optical wave from the second optical wave.

Embodiment 20: The method of embodiment 19, comprising forming a third layer, between at least a portion of the volume between the first layer and the second layer, in which the third layer comprises the dielectric material.

Embodiment 21: The method of embodiment 20, further comprising:
forming a first electrode contacting a portion of the first doped region on a first side of the segment of the dielectric material;
forming a second electrode contacting a portion of the second doped region on the first side of the segment of the dielectric material;
forming a third electrode contacting a portion of the first doped region on a second side of the segment of the dielectric material; and
forming a fourth electrode contacting a portion of the second doped region on the second side of the segment of the dielectric material.

Embodiment 22: The method of embodiment 21, wherein the first layer is above the second layer, and the portion of the second doped region on the first side of the segment of the dielectric material extends further along the lateral axis from the segment of the dielectric material than the portion of the first doped region on the first side of the segment of the dielectric material.

Embodiment 23: The method of embodiment 22, wherein the portion of the second doped region on the second side of the segment of the dielectric material extends further along the lateral axis from the segment of the dielectric material than the portion of the first doped region on the second side of the segment of the dielectric material.

Embodiment 24: The method of any of embodiments 20 to 23, further comprising forming a fourth layer, between the substrate and the first layer, in which the fourth layer comprises the dielectric material.

Embodiment 25: The method of embodiment 24, wherein the fourth layer comprises a buried oxide layer of a silicon on insulator (SOI) integrated circuit.

Embodiment 26: The method of embodiment 24 or 25, wherein the segment of the dielectric material contacts the fourth layer.

Embodiment 27: The method of embodiment 26, wherein the first layer and the second layer each include a segment of the dielectric material separating two portions of its respective doped region across the lateral axis to separate the peak of an optical spatial mode of the first optical wave from the peak of an optical spatial mode of the second optical wave.

Embodiment 28: The method of embodiment 27, wherein the segment of the first layer and the segment of the second layer each contact the third layer.

Embodiment 29: The method of any of embodiments 24 to 28, further comprising forming a fifth layer, above both the first layer and the second layer, in which the fifth layer comprises the dielectric material.

Embodiment 30: The method of any of embodiments 19 to 29, wherein the segment of the dielectric material separates a first ridge of the first semiconductor material of the first layer and a second ridge of the first semiconductor material of the first layer, the first ridge extends along the propagation axis to provide a first waveguide section to guide the optical spatial mode of the first optical wave, and the second ridge extends along the propagation axis to provide a second waveguide section to guide the optical spatial mode of the second optical wave.

Embodiment 31: The method of embodiment 30, comprising forming portions of respective arms of an interferometric structure using the first waveguide section and the second waveguide section.

Embodiment 32: The method of embodiment 31, comprising forming a Mach-Zehnder interferometer that comprises the interferometric structure.

Embodiment 33: The method of any of embodiments 30 to 32, wherein each of the first waveguide section and the second waveguide section comprises a semiconductor-insulator-semiconductor capacitor (SISCAP).

Embodiment 34: The method of any of embodiments 19 to 33, wherein a size of the segment of the dielectric material separating two portions of its respective doped region across the lateral axis is between about 1 micron to 50 microns.

Embodiment 35: The method of embodiment 34, wherein a size of the segment of the dielectric material separating two portions of its respective doped region across the lateral axis is between about 2 microns to 20 microns.

Embodiment 36: The method of any of embodiments 19 to 35, wherein different portions of the first doped region have different concentrations of dopant, and different portions of the second doped region have different concentrations of dopant.

Embodiment 37: An apparatus comprising:
a dual-waveguide optical phase modulator comprising a first waveguide and a second waveguide, in which each of the first and second waveguides comprises:
   a first waveguide core structure and a second waveguide core structure, in which at least one of the first waveguide core structure or the second waveguide core structure includes a ridge.

Embodiment 38: The apparatus of embodiment 37 in which the first waveguide and the second waveguide extend along a propagation direction, and
the first waveguide core structure and the second waveguide core structure are spaced apart in a depth direction perpendicular to the propagation direction.

Embodiment 39: The apparatus of embodiment 38 in which the first waveguide core structure comprises a first semiconductor material including a first doped region that exhibits a first conductivity type, and the second waveguide core structure comprises a second semiconductor material including a second doped region that exhibits a second conductivity type opposite from the first conductivity type.

Embodiment 40: The apparatus of embodiment 39 in which each of the first waveguide and the second waveguide comprises a dielectric material disposed between the first waveguide core structure and the second waveguide core structure.

Embodiment 41: The apparatus of any of embodiments 37 to 40 in which the first waveguide and the second waveguide extend along a propagation direction, and the first waveguide core structure of the first waveguide is spaced apart from the first waveguide core structure of the second waveguide in a lateral direction perpendicular to the propagation direction.

Embodiment 42: The apparatus of embodiment 41, in which the first waveguide core structure includes the ridge.

Embodiment 43: The apparatus of embodiment 42, in which the second waveguide core structure includes the ridge.

Embodiment 44: The apparatus of embodiment 42, in which the second waveguide core structure does not include a ridge.

Embodiment 45: The apparatus of embodiment 41, in which the second waveguide core structure includes the ridge, and the first waveguide core structure does not include a ridge.

Embodiment 46: The apparatus of embodiment 41, in which the second waveguide core structure of the first waveguide and the second waveguide core structure of the second waveguide form a continuous waveguide core structure.

Embodiment 47: The apparatus of embodiment 41, in which the second waveguide core structure of the first waveguide is spaced apart from the second waveguide core structure of the second waveguide in a lateral direction perpendicular to the propagation direction.

Embodiment 48: The apparatus of any of embodiments 41 to 47 in which the first waveguide core structure of each of the first waveguide and the second waveguide comprises a first semiconductor material including a first doped region that exhibits a first conductivity type, and
wherein the dual-waveguide optical phase modulator comprises a segment of a dielectric material disposed between the first waveguide core structure of the first waveguide and the first waveguide core structure of the second waveguide.

Embodiment 49: The apparatus of embodiment 48 in which the segment of the dielectric material is configured to separate a peak of an optical spatial mode of a first optical wave propagating in the first waveguide from a peak of an optical spatial mode of a second optical wave propagating in the second waveguide.

Embodiment 50: The apparatus of embodiment 48 or 49 in which the second waveguide core structure of each of the first waveguide and the second waveguide comprises a second semiconductor material including a second doped region that exhibits a second conductivity type opposite from the first conductivity type, and
wherein the dual-waveguide optical phase modulator comprises a segment of dielectric material disposed between the second waveguide core structure of the first waveguide and the second waveguide core structure of the second waveguide.

Embodiment 51: The apparatus of embodiment 48 or 49 in which the second waveguide core structure of the first waveguide and the second waveguide core structure of the second waveguide form a continuous waveguide core structure and comprises a second semiconductor material including a second doped region that exhibits a second conductivity type opposite from the first conductivity type.

Embodiment 52: The apparatus of any of embodiments 48 to 51, comprising:
a first pair of electrodes electrically coupled to the first and second waveguide core structures of the first waveguide, and
a second pair of electrodes electrically coupled to the first and second waveguide core structures of the second waveguide,
wherein the first pair of electrodes are disposed at a first side in a lateral direction relative to the dielectric material, and the second pair of electrodes are disposed at a second side in a lateral direction relative to the dielectric material.

Embodiment 53: The apparatus of any of embodiments 37 to 52, comprising a substrate, in which the first waveguide core structure is formed in a first layer above the substrate, the second waveguide core structure is formed in a second layer above the substrate, and the first layer is above the second layer.

Embodiment 54: The apparatus of any of embodiments 37 to 53 in which each of the first waveguide and the second waveguide comprises a semiconductor-insulator-semiconductor capacitor (SISCAP).

Embodiment 55: The apparatus of any of embodiments 48 to 54 in which the segment of the dielectric material separates a first ridge of the first waveguide and a second ridge of the second waveguide, the first ridge extends along a propagation direction of the first waveguide to provide a first waveguide section to guide an optical spatial mode of a first optical wave propagating in the first waveguide, and the second ridge extends along a propagation direction of the second waveguide to provide a second waveguide section to guide an optical spatial mode of a second optical wave propagating in the second waveguide.

Embodiment 56: The apparatus of any of embodiments 37 to 55, comprising an interferometric structure, in which the first waveguide and the second waveguide are configured to form portions of respective arms of the interferometric structure.

Embodiment 57: The apparatus of embodiment 56, comprising a Mach-Zehnder interferometer that comprises the interferometric structure.

Embodiment 58: The apparatus of any of embodiments 48 to 57 in which the segment of the dielectric material is configured to separate the first waveguide core structure of the first waveguide from the first waveguide core structure of the second waveguide at a distance in a range from 1 micron to 50 microns.

Embodiment 59: The apparatus of embodiment 58 in which the segment of the dielectric material is configured to separate the first waveguide core structure of the first waveguide from the first waveguide core structure of the second waveguide at a distance in a range from 2 microns to 20 microns.

Embodiment 60: The apparatus of any of embodiments 48 to 59 in which different portions of the first doped region have different concentrations of dopant.

Embodiment 61: The apparatus of any of embodiments 50 to 60 in which different portions of the second doped region have different concentrations of dopant.

Embodiment 62: The apparatus of any of embodiments 37 to 61 in which on a plane perpendicular to a propagation direction of the first and second waveguides, the first waveguide is symmetrical to the second waveguide with respect to a midline between the first waveguide and the second waveguide.

Embodiment 63: The apparatus of any of embodiments 37 to 61 in which the first waveguide is symmetrical to the second waveguide with respect to a plane between the first waveguide and the second waveguide.

Embodiment 64: A system comprising:
a processor unit comprising:
   a light source configured to provide a plurality of light outputs;
   a plurality of optical modulators coupled to the light source and the first unit, the plurality of optical modulators being configured to generate an optical input vector by modulating the plurality of light outputs provided by the light source based on a plurality of modulator control signals, the optical input vector comprising a plurality of optical signals; and
   a matrix multiplication unit coupled to the plurality of optical modulators, the matrix multiplication unit being configured to transform the optical input vector into an output vector based on a plurality of weight control signals;
wherein at least one of the optical modulators comprises the integrated photonic device of any of embodiments 1 to 18, or the apparatus of any of embodiments 37 to 63, or an integrated photonic device fabricated according to the method of any of embodiments 19 to 36.

Embodiment 65: The system of embodiment 64 in which each of the optical modulators comprises the integrated photonic device of any of embodiments 1 to 18, or the apparatus of any of embodiments 37 to 63, or an integrated photonic device fabricated according to the method of any of embodiments 19 to 36.

Embodiment 66: An optical processor that comprises a plurality of optical modulators, in which at least one of the optical modulators comprises the integrated photonic device of any of embodiments 1 to 18, or the apparatus of any of embodiments 37 to 63, or an integrated photonic device fabricated according to the method of any of embodiments 19 to 36.

Embodiment 67: The optical processor of embodiment 66 in which each of the plurality of optical modulators comprises the integrated photonic device of any of embodiments 1 to 18, or the apparatus of any of embodiments 37 to 63, or an integrated photonic device fabricated according to the method of any of embodiments 19 to 36.

Embodiment 68: A system comprising at least one of a robot, an autonomous vehicle, an autonomous drone, a medical diagnosis system, a fraud detection system, a weather prediction system, a financial forecast system, a facial recognition system, a speech recognition system, or a product defect detection system,
wherein the at least one of a robot, an autonomous vehicle, an autonomous drone, a medical diagnosis system, a fraud detection system, a weather prediction system, a financial forecast system, a facial recognition system, a speech recognition system, or a product defect detection system comprises the integrated photonic device of any of embodiments 1 to 18, or the apparatus of any of embodiments 37 to 63, or an integrated photonic device fabricated according to the method of any of embodiments 19 to 36.

1. An integrated photonic device configured to operate on optical waves, the integrated photonic device comprising:
a substrate supporting structures formed in a plurality of layers of materials with respect to three mutually perpendicular axes comprising:
a propagation axis along which two or more of the optical waves propagate over a segment of the photonic device,
a depth axis defining depths at which the plurality of layers are formed, and
a lateral axis perpendicular to the propagation axis and perpendicular to the depth axis; and
an optical phase shifting structure for phase shifting a first optical wave and a second optical wave of the two or more optical waves comprising:
a first layer, above the substrate, comprising a first semiconductor material including a first doped region that exhibits a first conductivity type, and
a second layer, above the substrate and separated from the first layer, comprising a second semiconductor material including a second doped region that exhibits a second conductivity type opposite from the first conductivity type;
wherein at least one of the first layer or the second layer includes at least one ridge of its respective semiconductor material extending along the depth axis into a portion of a volume between the first layer and the second layer; and
wherein at least one of the first layer or the second layer includes a segment of the dielectric material separating two portions of its respective doped region across the lateral axis to separate the first optical wave from the second optical wave.

2. The integrated photonic device of claim 1, further comprising a third layer, between at least a portion of the volume between the first layer and the second layer, comprising the dielectric material.

3. The integrated photonic device of claim 2, further comprising:
a first electrode contacting a portion of the first doped region on a first side of the segment of the dielectric material;
a second electrode contacting a portion of the second doped region on the first side of the segment of the dielectric material;
a third electrode contacting a portion of the first doped region on a second side of the segment of the dielectric material; and
a fourth electrode contacting a portion of the second doped region on the second side of the segment of the dielectric material.

4. The integrated photonic device of claim 3, wherein the first layer is above the second layer, and the portion of the second doped region on the first side of the segment of the dielectric material extends further along the lateral axis from the segment of the dielectric material than the portion of the first doped region on the first side of the segment of the dielectric material.

5. The integrated photonic device of claim 4, wherein the portion of the second doped region on the second side of the segment of the dielectric material extends further along the lateral axis from the segment of the dielectric material than the portion of the first doped region on the second side of the segment of the dielectric material.

6. The integrated photonic device of claim 2, further comprising a fourth layer, between the substrate and the first layer, comprising the dielectric material.

7. The integrated photonic device of claim 6, wherein the fourth layer comprises a buried oxide layer of a silicon on insulator (SOI) integrated circuit.

8. The integrated photonic device of claim 6, wherein the segment of the dielectric material contacts the fourth layer.

9. The integrated photonic device of claim 8, wherein the first layer and the second layer each include a segment of the dielectric material separating two portions of its respective doped region across the lateral axis to separate the peak of an optical spatial mode of the first optical wave from the peak of an optical spatial mode of the second optical wave.

10. The integrated photonic device of claim 9, wherein the segment of the first layer and the segment of the second layer each contact the third layer.

11. The integrated photonic device of claim 6, further comprising a fifth layer, above both the first layer and the second layer, comprising the dielectric material.

12. The integrated photonic device of claim 1, wherein the segment of the dielectric material separates a first ridge of the first semiconductor material of the first layer and a second ridge of the first semiconductor material of the first layer, the first ridge extends along the propagation axis to provide a first waveguide section to guide the optical spatial mode of the first optical wave, and the second ridge extends along the propagation axis to provide a second waveguide section to guide the optical spatial mode of the second optical wave.

13. The integrated photonic device of claim 12, wherein the first waveguide section and the second waveguide section are configured to form portions of respective arms of an interferometric structure.

14. The integrated photonic device of claim 13, wherein the interferometric structure comprises at least a portion of a Mach-Zehnder interferometer.

15. The integrated photonic device of claim 12, wherein each of the first waveguide section and the second waveguide section comprises a semiconductor-insulator-semiconductor capacitor (SISCAP).

16. The integrated photonic device of claim 1, wherein a size of the segment of the dielectric material separating two portions of its respective doped region across the lateral axis is between about 1 micron to 50 microns.

17. The integrated photonic device of claim 16, wherein a size of the segment of the dielectric material separating two portions of its respective doped region across the lateral axis is between about 2 microns to 20 microns.

18. The integrated photonic device of claim 1, wherein different portions of the first doped region have different concentrations of dopant, and different portions of the second doped region have different concentrations of dopant.

19. A method for fabricating an integrated photonic device configured to operate on optical waves, the method comprising:
forming a substrate supporting structures formed in a plurality of layers of materials with respect to three mutually perpendicular axes comprising:
a propagation axis along which two or more of the optical waves propagate over a segment of the photonic device,
a depth axis defining depths at which the plurality of layers are formed, and
a lateral axis perpendicular to the propagation axis and perpendicular to the depth axis;
forming an optical phase shifting structure for phase shifting a first optical wave and a second optical wave of the two or more optical waves comprising:
a first layer, above the substrate, comprising a first semiconductor material including a first doped region that exhibits a first conductivity type, and
a second layer, above the substrate and separated from the first layer, comprising a second semiconductor material including a second doped region that exhibits a second conductivity type opposite from the first conductivity type;
forming in at least one of the first layer or the second layer at least one ridge of its respective semiconductor material extending along the depth axis into a portion of a volume between the first layer and the second layer; and
forming in at least one of the first layer or the second layer a segment of the dielectric material separating two portions of its respective doped region across the lateral axis to separate the first optical wave from the second optical wave.

20. The method of claim 19, comprising forming a third layer, between at least a portion of the volume between the first layer and the second layer, in which the third layer comprises the dielectric material.

21-68. (canceled)
